(19) United States
(12) Patent Application Publication
(10) Pub. No.: US 2010/0076831 A1
(43) Pub. Date: Mar. 25, 2010

(54) CUSTOMER REWARDS SYSTEMS AND METHODS FOR SOCIAL NETWORKING APPLICATIONS

(76) Inventor: Ehab Samuel, Tustin, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/408,216

(22) Filed: Mar. 20, 2009

Related U.S. Application Data
(60) Provisional application No. 61/098,558, filed on Sep. 19, 2008.

(51) Int. Cl. G06Q 30/00; G06F 15/16; G06Q 99/00

(52) U.S. Cl. 705/14.16; 709/204; 705/1

(57) ABSTRACT

Customer rewards systems and methods for social networking applications, such as e-mail applications, calendar applications, chat room applications, instant messaging applications, and media management and sharing applications, are provided. The system includes a first memory, a second memory and a processor. The first memory stores a plurality of web pages having a social networking application. The second memory stores data associated with a customer account for a user to access the social networking application. The processor being configured to receive the data from a user terminal, verify the user's membership for accessing the social networking application, and transfer an award to the customer account upon access to one of the plurality of web pages with the social networking application.

### RELATED APPLICATION

This application claims the benefit of and priority to U.S. Provisional Application Ser. No. 61/098,558, filed Sep. 19, 2008, the contents of which are incorporated by reference herein in its entirety.

### BACKGROUND

This disclosure relates generally to social networking applications. More particularly, this disclosure relates to customer rewards systems and methods for social networking applications.

### SUMMARY

Customer rewards systems and methods for social networking applications, such as e-mail applications, calendar applications, chat room applications, instant messaging applications, and media management and sharing applications, are provided. The system includes a first memory, a second memory and a processor. The first memory stores a plurality of web pages having a social networking application. The second memory stores data associated with a customer account for a user to access the social networking application. The processor being configured to receive the data from a user terminal, verify the user's membership for accessing the social networking application, transfer an award to the customer account upon access to one of the plurality of web pages with the social networking application, and process the user's directive for redeeming the award towards a product or service.

In one embodiment, the processor may be further configured to receive a request to identify at least one other person as a friend of the user, store in the second memory at least one media file uploaded to the website by the user, and receive a request from the user to share with the at least one other person identified as a friend the at least one media file uploaded to the website. The processor may be further configured to transfer an award to the customer account when the at least one other person identified as a friend views the at least one photo posted on the website. The processor may also be configured to transfer an award to the customer account for inviting at least one other person identified as a friend to join the website.

A computer-implemented process for promoting customer loyalty to a website with a social networking application is also provided. The process includes establishing online a customer account for a user to access the website, receiving a first request code to access the social networking application of the website, and transferring an award associated with the customer account to an award database upon access of at least one webpage with the social networking application. The award may be a dollar amount, a cash value and a credit point. The award may be applied as a credit towards the user's cell phone or internet account.

In one embodiment, the computer-implemented process may include receiving a request to identify at least one other person as a friend of the user, receiving at least one photo to post on the website by the user using the photo management and sharing application, storing the at least one photo in a photo sharing database, and receiving a second request code from the user to share with the at least one other person identified as a friend the at least one photo posted on the website. The computer-implemented process may also include transferring an award associated with the customer account to the award database when the at least one other person identified as a friend views the at least one photo posted on the website. Furthermore, the computer-implemented method may include providing at least one advertisement for display on the at least one webpage with the social networking application.

A system for promoting customer loyalty to a website with a social networking application is also provided. The system may include a database, a processing module, a social networking module, an award manager module and an advertising module. The database stores data associated with a customer account for a user to access the social networking application. The processing module responsive to the receipt of the data associated with the customer account upon log in to the website, the processing module verifies the user's membership for accessing the social networking application. The social networking module responsive to a request to use a social networking application selected from a group consisting of an e-mail application, a calendar application, a chat room application, an instant messaging application, and a media management and sharing application. The award manager module responsive to a request to access a webpage on the social networking application, the award module transfers an award to the customer account in response to the request received, stores the award in the database, and is responsive to a user's directive to redeem the award towards a product or service. The advertising module is responsive to a request to access a webpage on the website, the advertising module retrieves from the database an advertisement to prompt for display on the webpage.

In one embodiment, the processing module is responsive to a user's request to identify at least one other person as a friend to access the social networking application. The processing module is responsive to a user's request to submit at least one media file for posting on the website using the media management and sharing application and share with the at least one other person identified as a friend. The processing module is responsive to the at least one media file received and prompting the at least one other person identified as a friend to view the at least one media file. The award manager module is responsive to the user's request to share with the at least one other person identified as a friend the at least one media file. The award manager module transfers an award to the customer account in response to the at least one other person identified as a friend viewing the at least one media file posted on the website.

### DRAWINGS

The above-mentioned features and objects of the present disclosure will become more apparent with reference to the following description taken in conjunction with the accompanying drawings wherein like reference numerals denote like elements and in which:

FIG. 1 illustrates a block diagram of a customer rewards system for a social networking application, according to an embodiment of the present disclosure.

FIG. 2 illustrates an exemplary flowchart outlining the operation of a customer rewards system for showcasing talent in an online social network, according to an embodiment of the present disclosure.

FIG. 3 illustrates an exemplary flowchart outlining the operation of a customer rewards system for inviting friends on an online social network to review an individual's media submission, according to an embodiment of the present disclosure.

FIG. 4 illustrates an exemplary flowchart outlining the operation of a customer rewards system implemented for a social networking application, according to an embodiment of the present disclosure.

FIG. 5 illustrates an exemplary flowchart outlining the operation of a customer rewards system implemented for a photo management and sharing application, according to an embodiment of the present disclosure.

FIG. 6 illustrates an exemplary flowchart outlining the operation of a customer rewards system implemented for identifying a top talent media submission, according to an embodiment of the present disclosure.

FIG. 7 illustrates a block diagram of a web-based system with an enhanced customer loyalty program, according to an embodiment of the present disclosure.

FIG. 8 illustrates an exemplary flowchart outlining the operation of a web-based system for enhanced customer loyalty implemented for a social networking application, according to an embodiment of the present disclosure.

FIG. 9 illustrates an exemplary flowchart outlining the operation of a web-based system for enhanced customer loyalty implemented for a photo management and sharing application, according to an embodiment of the present disclosure.

### DETAILED DESCRIPTION

In the description that follows, the present disclosure will be described in reference to preferred embodiments that relates to customer rewards systems and methods for social networking applications. The present disclosure, however, is not limited to any particular application nor is it limited by the examples described herein. Therefore, the description of the embodiments that follow are for purposes of illustration and not limitation.

For the purposes of this disclosure, the term “content” or “media” is used broadly to encompass any product type or category of creative work including any work that is in an electronic form that is renderable, experienceable, retrievable, computer-readable filed and/or stored in memory, either singly or collectively. Individual items of content or media include songs, tracks, pictures, images, movies, articles, books, ratings, reviews, descriptive tags, or computer-readable files, however, the use of any one term is not to be considered limiting as the concepts features and functions described herein are generally intended to apply to any work that may be experienced by a user, whether aurally, visually or otherwise, in any manner now known or to become known. Further, the term content or media includes audio, video and products embodying the same. As mentioned above, while there are many digital forms and standards for audio, video, digital or analog media data and content, embodiments of the systems and methods described herein may be equally adapted to any format or standard now known or to become known.

Additionally, the term “talent” refer to an identifiable entity such as an individual, groups of individuals, or legal entities such as partnerships and corporations who create and/or distribute any form of content. The term “top talent,” on the other hand, refers to those leading entities that are popular, successful, or likely to become so, because of the quality, popularity, utility or timeliness of the content they create. Thus, top talent refers to a specific subset of talent that are of interest to marketers, distributors and corporate interests.

For purposes of this disclosure, the term “social network” refers to an online community in which community members can interact or transfer information and can include chat rooms, email accounts, forums, instant messaging, media/photo management and sharing. Further, the term “social network” refers to a web-based system for facilitating applications such as e-mail application, calendar application, chat room application, instant messaging application, and media/photo management and sharing application.

Embodiments of the present disclosure include systems and methods for identifying individuals of media submissions, monitoring the popularity of the media submission over time and identifying top talent that is likely to become more popular in the future based on peer and expert review. The systems and methods are further adapted to transfer an award for peer review submission to a user account and process an individual's directive for redeeming the award towards a product or service.

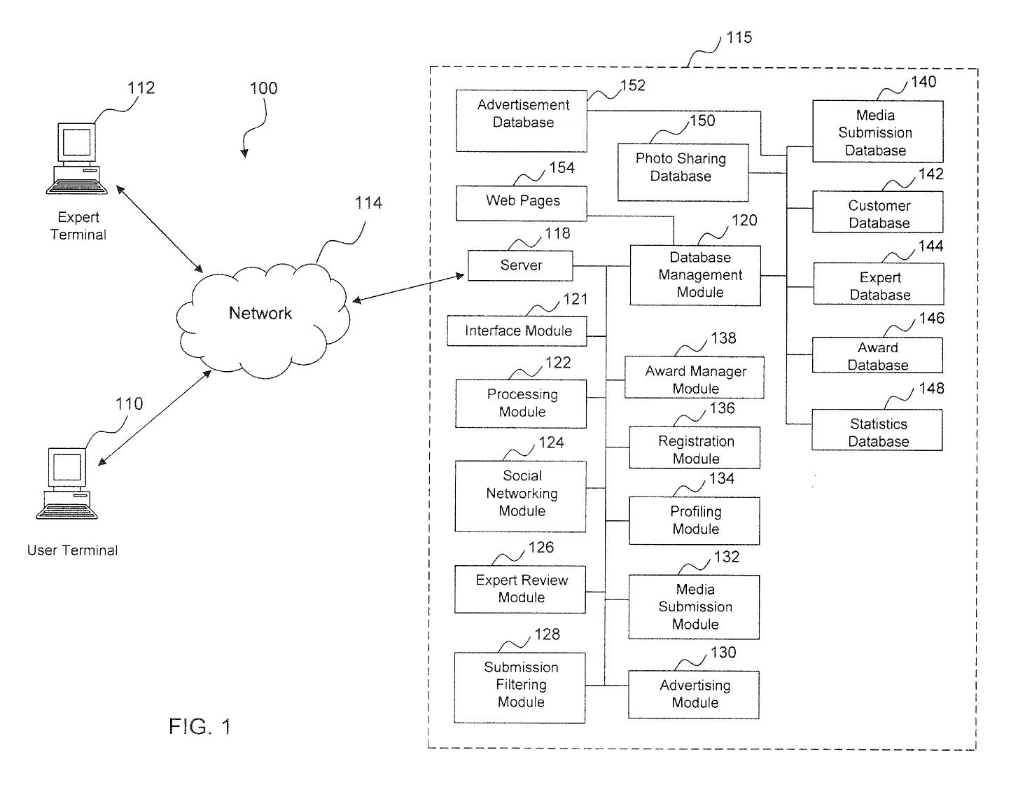

FIG. 1 illustrates a block diagram of a customer rewards system 100 for a social networking application, according to an embodiment of the present disclosure. A social networking website 115 may be accessible to a user terminal 110 and an expert terminal 112, such as personal computers, phones and personal digital assistants, via a network 114. The terminals 110, 112 may run commercially-available Web browser applications such as Microsoft Internet Explorer®, which implements World Wide Web standards such as HTTP, HTML, XML, java, Flex, Ajax and the like.

In one embodiment, the social networking website 115 may include a server 118, one or more modules and one or more databases. The website content may be distributed over several Internet domains, and may be implemented using several servers located at various locations. Of course, a variety of networks, both public and private, may be used as well. The social networking website 115 may use a commercially-available Internet server 118 which accesses a web page database 154 that may be used to store and/or dynamically generate Web pages in response to end user actions. The Web pages may be in the form of HTML pages or the like.

The social networking website 115 may be implemented as one or more functional modules including a database management module 120, an interface module 121, a processing module 122, a social networking module 124, an expert review module 126, a submission filtering module 128, an advertising module 130, a media submission module 132, a profiling module 134, a registration module 136, and an award manager module 138. As used herein, the term module refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules are implemented in C++ and compiled on a computer running a content server, such as, for example, Microsoft™ IIS or Linux™ Apache. Alternatively, the code modules can be compiled with their own front end on a kiosk, or can be compiled on a cluster of server machines serving interactive television content through a cable, packet, telephone, satellite, or other telecommunications network. Artisans of skill in the art will recognize that any number of implementations, including code implementations directly to hardware, are also possible.

The database management module 120 may be used to provide database management functions for interrelated databases, including, for example, a media submission database 140, a customer database 142, an expert database 144, an award database 146, a statistics database 148, a photo sharing database 150, an advertisement database 152 and a web pages database 154. As is well known, database categories above can be combined, further divided or cross-correlated, and any combination of databases 140, 142, 144, 146, 148, 150, 152, 154 and the like can be provided from within the server 118. In one embodiment, any portion of the databases can be provided externally from the social networking website 115, either locally on the server 118, or remotely over a network. The external data from an external database can be provided in any standardized form which the server 118 can understand. For example, an external database at a provider can advantageously provide end-user data in response to requests from server 118 in a standard format, such as, for example, name, user identification, and computer identification number, and the like, and the end-user data blocks are transformed by the database management module 120 into a function call format which the code modules can understand. The database management module 120 may be a standard SQL server, where dynamic requests from the server 118 build forms from the various databases used by social networking website 115 as well as store and retrieve related data on the various databases.

As can be appreciated, the databases may be used to store, arrange and retrieve data. The databases may be storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

In one embodiment, the media submission database 140 may be used to store unsolicited submissions of media from a plurality of individuals demonstrating their talent. The customer database 142 may be used to store data associated with a customer account for a user to access the social networking website 115. For example, the customer database 142 may be used to store sign up information associated with a customer account in the social networking website 115. The customer database 142 may also be used to store customer profile data based on talent genre and generated from the sign up information. The talent genre may, for example, include talent categories, such as sports (i.e. basketball, soccer, football, etc.), arts (i.e. painting, singing, dancing etc.), and the like. The expert database 144 may be used to store data, such as contact information, reviews, and the like, for individuals identified as experts within a talent genre. The award database 146 may be used to store and/or accumulate an award associated with a customer account. The award may be a dollar amount, a cash value, a credit point, or a combination thereof. The statistics database 148 may be used to store data associated with a score and/or a rank of media submissions in a talent genre based on peer and/or expert review. The photo sharing database 150 may be used to store at least one photo image file associated with a customer account. The advertisement database 152 may be used to store advertisement data for display with web pages retrieved from the web pages database 154.

The interface module 121 may be operatively associated with a number of different modules. For example, the interface module 121 may be operatively associated with registration module 136 to register users to the social networking website 115. The interface module 121 may be implemented to receive an identifier, such as an account username and password, for logging onto the social networking website 115 and for accessing associated customer account. The interface module 121 may also be used to provide search results executed by the submission filtering module 128 to the user's terminal 110.

The processing module 122 may be responsive to the receipt of user or customer information upon log in to the social networking website 115. The processing module 122 may be used to retrieve a customer profile data in response to the customer information entered upon log in. The processing module 122 may also retrieve at least two submissions randomly selected from a database and having a talent genre the same as the customer profile data. In one embodiment, the processing module 122 may prompt the at least two submissions for customer peer review upon log in to the social networking website 115. The peer review may be a rating on a predetermined scale for the at least two submissions.

In one embodiment, the processing module 122 is responsive to a customer's request to identify at least one other person as a friend of the customer on the social networking website 115. The processing module 122 may be responsive to a customer's request to invite the at least one other person identified as a friend to review the customer's media submission and may be used to prompt the customer's media submission for review by the at least one other person identified as a friend. The processing module 122 may also be responsive to a customer's request to submit at least one media file, such as an image file, for posting on the social networking website 115 using the media/photo management and sharing application and to share with the at least one other person identified as a friend. The processing module 122 may be responsive to the at least one image file received and may be used to prompt the at least one other person identified as a friend to view the at least one image.

As can be appreciated, the processing module 122 may also be responsive to the receipt of at least one peer review submission for the customer's media submission. The processing module 122 may be used to compile the at least one peer review submission, compute a score based on the at least one peer review submission, and statistically determine the ranking of the customer within the customer's talent genre as determined from the customer profile data.

The social networking module 124 may be operatively associated with one or more modules for facilitating electronic communication between individuals on the network 114, for example, facilitating the use of a social networking application having one or more of an e-mail application, a calendar application, a chat room application, an instant messaging application, and a photo management and sharing application. The social networking application 124 may be operatively associated with the award manager module 138 for transferring an award to the individual's user account for using the social networking application. In one embodiment, the social networking module 124 may be used identify at least one other person as a friend of the individual on the social networking website 115. The social networking module 124 may also be used to display a video of at least a portion of the friend's media submission on the individual's user account web page, and link the video to an e-mail associated with the friend.

In one embodiment, the social networking module 124 may be used to identify at least one other person as a friend of an individual on the social networking website 115, receive at least one photo posted on the social networking website 115 by the individual using the photo management and sharing application, store the at least one photo in a photo sharing database 150, and receive a request from the individual to share with the at least one other person identified as a friend the at least one photo posted on the social networking website 115 by the individual.

The expert review module 126 may be responsive to the determination of the ranking of a user's media submission. The expert review module 126 may select one or more top ranking media submissions based on a predetermined threshold, and being responsive to the customer profile data, may be used to determine at least one expert having a talent genre the same as the customer profile data for the one or more top ranking media submissions. In one embodiment, the expert review module 126 may prompt the at least one expert on his/her expert terminal 112 to review the one or more top ranking media submissions. The expert review module 126 may be responsive to an expert review of the one or more top ranking media submissions for identifying at least one media submission reviewed by the at least one expert as a top talent submission based on a predetermined threshold. In one embodiment, the expert review module 126 may be used to provide or transmit the top talent submission to a third party entity for consideration in engaging the individual of the top talent submission in a talent contract with the third party entity.

The expert review module 126 may be operatively associated with a search engine, for example, the submission filtering module 128, to filter, based on a certain threshold, through the at least one media submission reviewed by the at least one expert or that was peer reviewed for providing the top talent submission to the third party entity. The submission filtering module 128 may also be accessible to the public for searching through and viewing unsolicited submissions of media on the social networking website 115. As can be appreciated, the submission filtering module 126 is responsive to a satisfaction of a filtering threshold to access the stored media submissions.

The social networking website 115 may be used to alert third party entity members of up and coming talent within specified genre and filtering criteria. By way of example, and not limitation, the third party entity may be a professional sports team in the NBA®, NHL®, NFL®, MLB®, MLS® and the like, a university or college seeking to attract talent to their varsity teams or university programs, a record label company, a talent agent or agency and the like.

In one embodiment, the social networking website 115 may also be used to broker new talent to third party entity members or subscribers. As such, the social networking website 115 may be used to provide agency and sales services, where a team of in-house agents work on behalf of members to promote, pitch, and sell media submissions and/or associated talented individuals to all related sectors. The agents may continually target and/or monitor top ranking media submissions that would be considered appealing to certain third party entity members, and then will pursue appropriate vendors to pitch and market the top ranking media submissions and/or associated talented individuals. Obviously, there is an economy of scale to receiving agency and sales services on an exchange, where services can be provided more economically because of the pooling of member resources. Moreover, existing agency services are typically only available to an elite few who have previous credits, which is a significant shortcoming in the art.

The advertising module 130 may be used to facilitate display of advertisement data on the social networking website 115. The advertising module 130 may be responsive to a request to access a web page or link on the social networking website 115. The advertising module 130 may be used to retrieve from the advertisement database 152 an advertisement data for display on a web page of the social networking website 115.

The media submission module 132 may be used to facilitate the submission of media on the social networking website 115. The media submission module 132 may be responsive to a request to submit an unsolicited media submission demonstrating talent. The media submission module 132 may also be responsive to unsolicited media submission received in response to the prompting for unsolicited media submission to store in the media submission database 140 at least part of the unsolicited media submission.

The profiling module 134 may be used to profile a user or customer based on his/her talent genre. The profiling module 134 may be responsive to the receipt of the customer information to profile the customer based on a talent genre from the customer information. The profiling module may provide instructions to store in the customer database 142 the customer profile data.

The registration module 136 may be used to facilitate registration with the social networking website 115. The registration module 136 may be responsive to a customer's request to register on the social networking website 115. The registration module 136 may be responsive to customer information received in response to the prompting of customer information to store in the customer database 142. The customer information may be used to set up a customer account with the social networking website 115.

The award manager module 138 may be used to transfer and/or accumulate awards to the award database 146 for one or more user accounts. In one embodiment, the award manager module 138 may be responsive to the receipt of the peer review submission. The award module 138 may transfer an award associated with a customer account in response to the receipt of the peer review submission and provide instructions to store the award in the award database 146. In one embodiment, the award manager module 138 may also be responsive to the receipt of review information of the customer's media submission from at least one other person identified as a friend. The award manager module 138 may be used to transfer an award associated with a customer account in response to review information received from the at least one other person identified as a friend. In another embodiment, the award manager module 138 may be responsive to a customer's request to invite at least one other person identified as a friend to join the social networking website 115. The award manager module 138 may be used to transfer an award associated with the customer's account in response to the invitation request.

In one embodiment, the award manager module 138 may be operatively associated with social networking module 124. For example, the award manager module 138 may be responsive to the customer's request to use the social networking applications provided by the social networking module 124 or access a web page stored in web page database 154. The award manager module 138 may transfer an award associated with a customer's account in response to the customer's use of the social networking application and/or accessing one or more web pages for the social networking website 115. Another example may include having the award manager module 138 responsive to a customer's request to share with the at least one other person identified as a friend the at least one image stored in photo sharing database 150. The award manager module 138 may be used to transfer an award associated with a customer's account in response to the at least one other person identified as a friend viewing the at least one photo stored in photo sharing database 150 and posted on the social networking website 115.

As can be appreciated, the award may be a dollar amount, a cash value, a credit point, or a combination thereof. The award manager module 138 may be used to process an individual's directive for redeeming the award towards a product or service. In one embodiment, the directive may be a selection of one or more options made available through the social networking website 115, including, accumulating an award in, individually or in combination, a regular savings or checking account, a money market account, a pre-tax savings account, a health savings account, a college tuition savings account, a charitable account, an investment account to purchase investment vehicles (i.e. stocks), and/or a retirement account. In one embodiment, the directive may be a selection for redeeming airline miles, hotel points, and/or membership rewards points on a plurality of products or services from one or more participating merchants. According to an embodiment, if a desired product or service requires an award greater than one that is accumulated in an individual's customer account, the accumulated award may be used as partial payment and supplemented with the individual's credit card, bank account or other form of payment to pay the remaining balance.

As is understood by a person skilled in the art, the code modules may be compiled on one or more servers 118, each having one or more processors, to perform a set of functional calls. In one embodiment, the one or more processors may be configured, programmed and/or provided code instructions from one or more modules to receive an individual's sign up information from a customer terminal, verify the individual's membership for accessing the social networking website 115, determine an individual's talent genre upon log in to the customer account of the social networking website 115, retrieve at least two submissions randomly selected from the media submission database 140 and having a talent genre the same as the individual's talent genre, provide the at least two submissions for peer review to the individual upon log in to the customer account, transfer an award for peer review submission to the customer account, and process the individual's directive for redeeming the award towards a product or service. The processor may also be configured, programmed and/or provided code instructions from one or more modules to determine at least one other person as a friend of the individual on the social networking website 115, and receive a request from the individual to invite the at least one other person identified as a friend to review the individual's media submission. The processor may further be configured, programmed and/or provided code instructions from one or more modules to provide the individual's media submission for review by the at least one other person identified as a friend. In one embodiment, the processor may also be configured, programmed and/or provided code instructions from one or more modules to determine at least one other person as a friend of the individual on the social networking website 115, retrieve a video of at least a portion of the friend's media submission for display on the individual's customer account, and link the video to an e-mail associated with the friend.

In one embodiment, the processor may be configured, programmed and/or provided code instructions from one or more modules to transfer an award to the individual's customer account for inviting the at least one other person identified as a friend to review the individual's media submission and/or for inviting the at least one other person identified as a friend to review the individual's media submission.

As can be appreciated, the processor may be configured, programmed and/or provided code instructions from one or more modules to determine at least one other person as a friend of the individual accessing the social networking application. The processor may receive at least one image file posted on the social networking website 115 by the individual using the photo management and sharing application, and receive a request from the individual to share with the at least one other person identified as a friend the at least one image file. The processor may further be configured, programmed and/or provided code instructions from one or more modules to transfer an award to the customer account when the at least one other person identified as a friend views the at least one photo posted on the social networking website 115.

In one embodiment, the processor may be configured, programmed and/or provided code instructions from one or more modules to compile at least one peer review submission for the individual's media submission, compute a score based on the at least one peer review submission, and statistically determine the ranking of the individual in the individual's talent genre.

The processor may also be configured, programmed and/or provided code instructions from one or more modules to determine one or more top ranking media submissions based on a predetermined threshold, determine at least one expert having a talent genre the same as the individuals' talent genre for the one or more top ranking media submissions, and provide the one or more top ranking media submissions for review by the at least one expert. The processor may then receive a review of the one or more top ranking media submissions from the at least one expert, identify at least one media submission reviewed by the at least one expert as a top talent submission based on a predetermined threshold, and provide the top talent submission to a third party entity for consideration in engaging the individual of the top talent submission in a talent contract with the third party entity.

In yet another embodiment, the processor may be configured, programmed and/or provided code instructions from one or more modules to identify at least one of the unsolicited submissions of media as a favorite for the individual having the customer account on the social networking website 115, and link the at least one of the unsolicited submissions of media identified as a favorite to the customer account. As can be appreciated, the processor may further be configured, programmed and/or provided code instructions from one or more modules to provide at least one advertisement for display on the customer account of the social networking website 115.

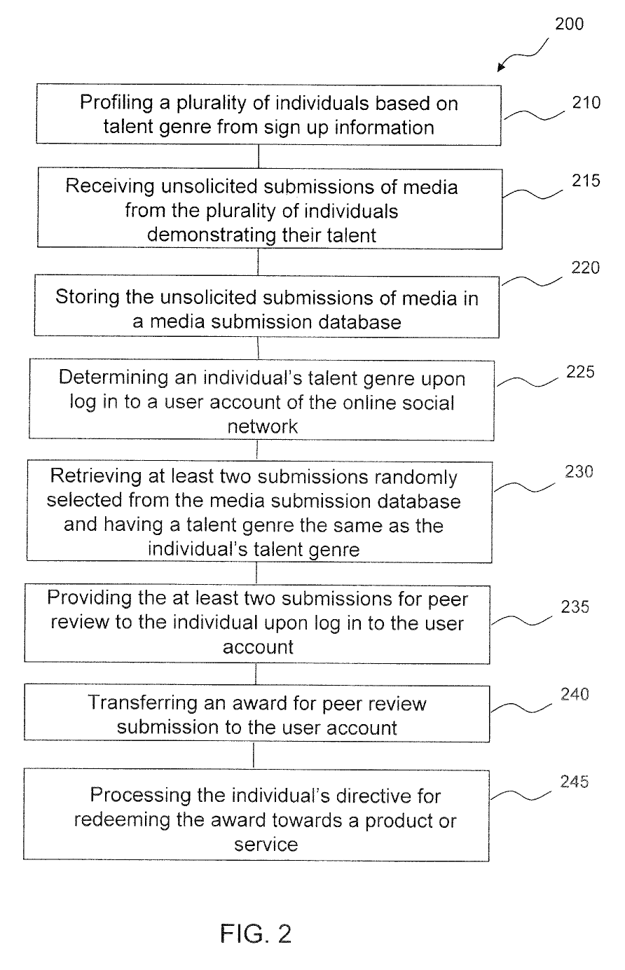

FIG. 2 illustrates an exemplary flowchart 200 outlining the operation of a customer rewards system for showcasing talent in an online social network, according to an embodiment of the present disclosure. The method of operation may include profiling a plurality of individuals based on talent genre from sign up information (210). Next, the customer rewards system receives unsolicited submissions of media from the plurality of individuals demonstrating their talent (215) and stores the unsolicited submissions of media in media submission database 140 (220). In one embodiment, the customer rewards system determines an individual's talent genre upon log in to a user account of the online social network (225), retrieves at least two submissions randomly selected from the media submission database 140 that has a talent genre the same as the individual's talent genre (230), and provides the at least two submissions for peer review to the individual upon log in to the user account (235). An award may then be transferred by the customer rewards system to the user account for peer review (240). The customer rewards system may then receive one or more directives from the user to redeem the award towards one or more products and/or services (245).

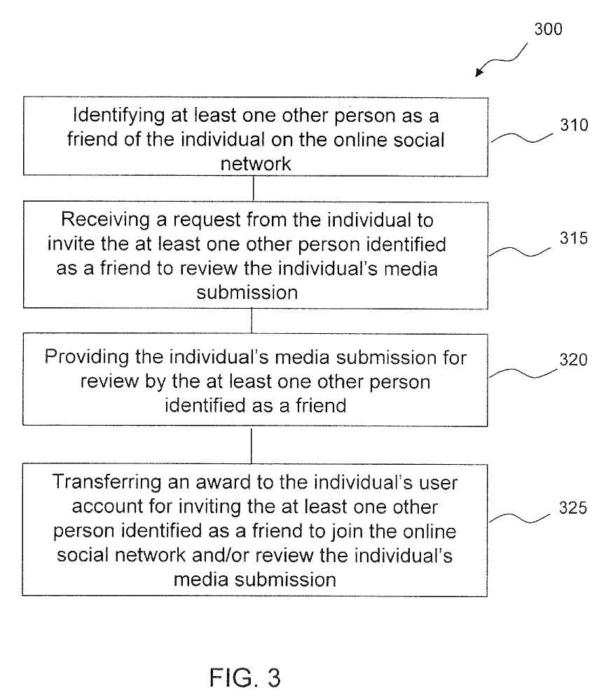

FIG. 3 illustrates an exemplary flowchart 300 outlining the operation of a customer rewards system for inviting friends on an online social network to review an individual's media submission, according to an embodiment of the present disclosure. The method of operation may include identifying at least one other person as a friend of the individual on the online social network (310) and receiving a request from the individual to invite the at least one other person identified as a friend to review the individual's media submission (315). Next, the customer rewards system provides the individual's media submission for review to the at least one other person identified as a friend (320). The customer rewards system may then transfer an award to the individual's user account for inviting the at least one other person identified as a friend to join the online social network and/or review the individual's media submission (325).

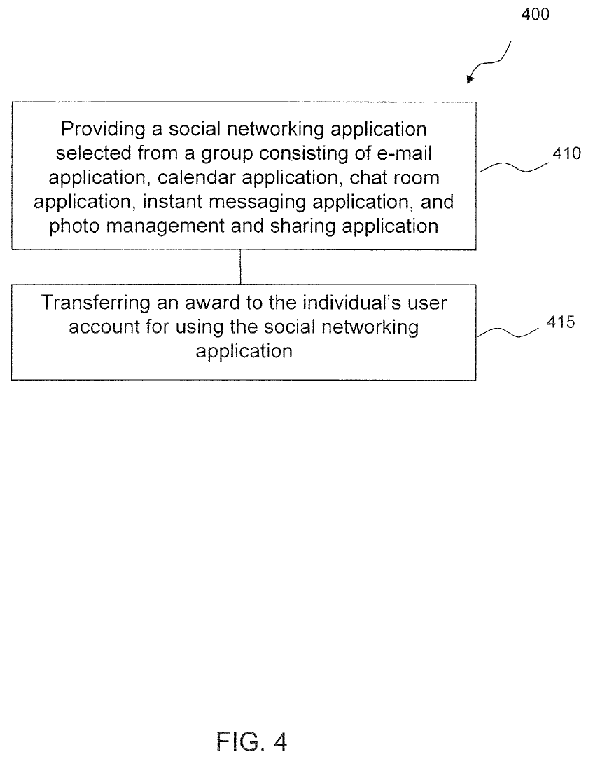

FIG. 4 illustrates an exemplary flowchart 400 outlining the operation of a customer rewards system implemented for a social networking application, according to an embodiment of the present disclosure. The method of operation may include providing a social networking application selected from a group consisting of e-mail application, calendar application, chat room application, instant messaging application, and photo management and sharing application (410) and transferring an award to the individual's user account for using the social networking application (415).

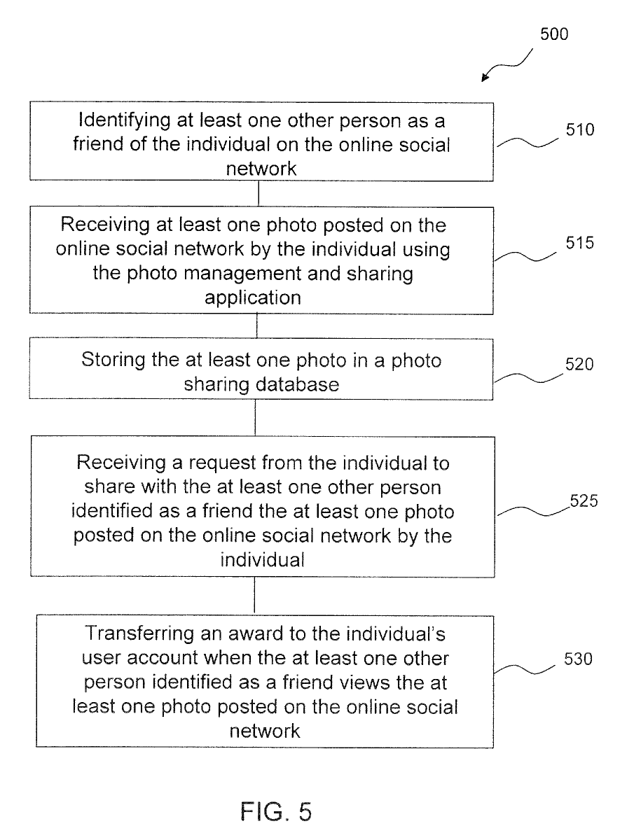

FIG. 5 illustrates an exemplary flowchart 500 outlining the operation of a customer rewards system implemented for a photo management and sharing application, according to an embodiment of the present disclosure. The method of operation may include identifying at least one other person as a friend of the individual on the online social network (510), receiving at least one photo posted on the online social network by the individual using the photo management and sharing application (515) and storing the at least one photo in a photo sharing database 150 (520). Next, the customer rewards system may receive a request from the individual to share with the at least one other person identified as a friend the at least one photo posted on the online social network by the individual (525). The customer rewards system may then transfer an award to the individual's user account when the at least one other person identified as a friend views the at least one photo posted on the online social network (530).

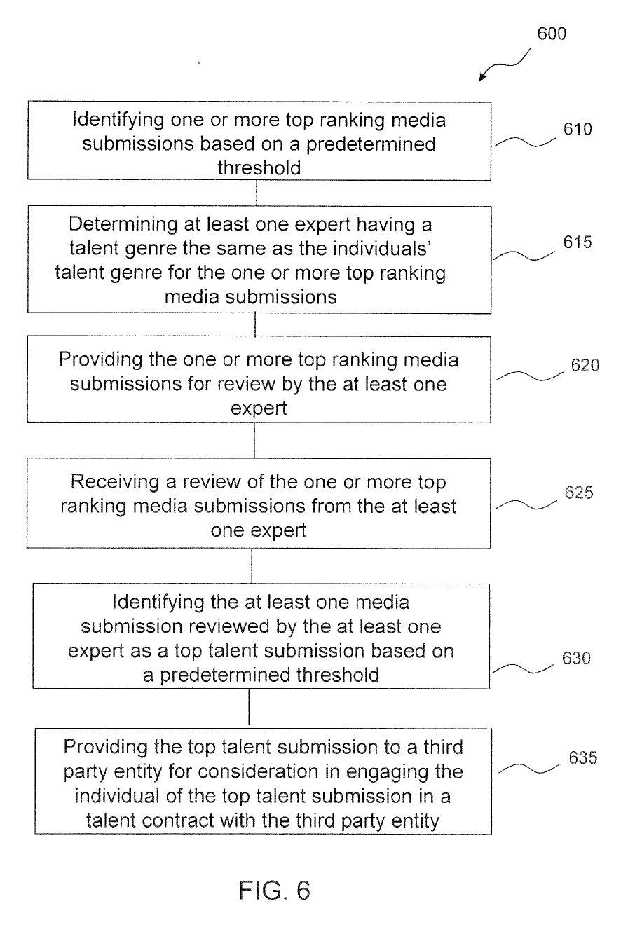

FIG. 6 illustrates an exemplary flowchart 600 outlining the operation of a customer rewards system implemented for identifying a top talent media submission, according to an embodiment of the present disclosure. The method of operation may include identifying one or more top ranking media submissions based on a predetermined threshold (610), determining at least one expert having a talent genre the same as the individuals' talent genre for the one or more top ranking media submissions (615), and providing the one or more top ranking media submissions for review by the at least one expert (620). The customer rewards system may then receive a review of the one or more top ranking media submissions from the at least one expert (625) and may identify the at least one media submission reviewed by the at least one expert as a top talent submission based on a predetermined threshold (630). Next, the customer rewards system may provide the top talent submission to a third party entity for consideration in engaging the individual of the top talent submission in a talent contract with the third party entity (635).

As can be appreciated, the customer rewards system may be implemented for any web-based service that facilitates communication between one or more individuals. For example, the customer rewards system may be implemented with an e-mail service such as one provided by Yahoo!® or Google®, to incentivize users to use the service provider's e-mail system, and as such creating customer loyalty among users of the e-mail system. Similarly, the customer rewards system may be implemented with a calendaring service, for example, for providing event notification, such as evitee. The customer rewards system may also be implemented with a photo management and sharing service, such as one provided by Flickr™, to incentivize users to post more pictures and share with their friends. This in turn, will generate more revenue for the service providers as more advertising revenue may be obtained through the increased use and customer loyalty provided by the customer rewards system of the present disclosure.

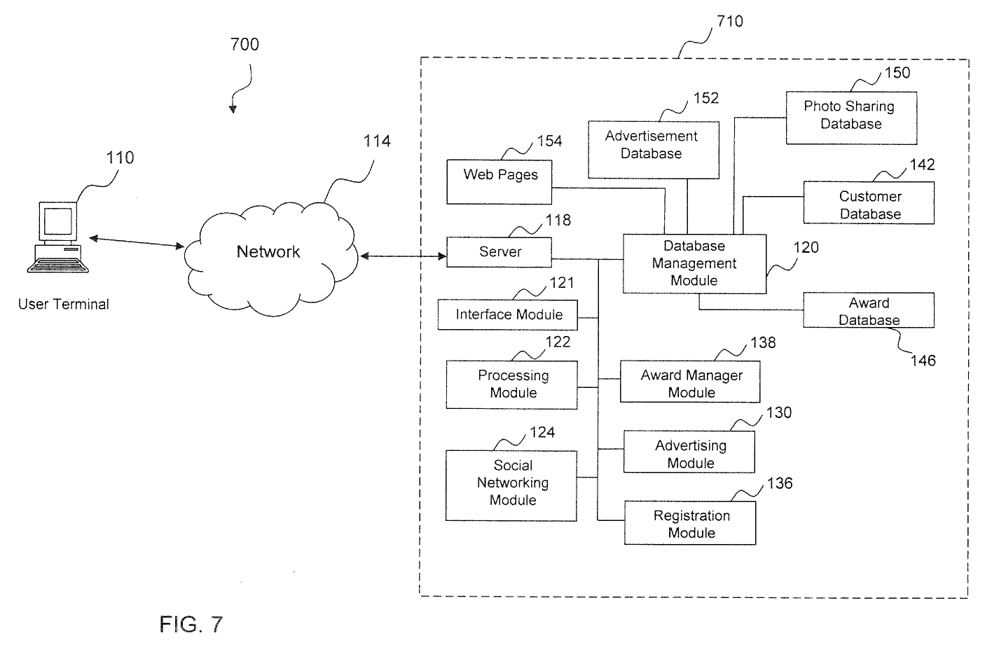

FIG. 7 illustrates a block diagram of a web-based system 700 with an enhanced customer loyalty program, according to an embodiment of the present disclosure. A user may utilize a user terminal 110 to connect to a website 710 via the network 114. In one embodiment, the website 710 may be used for a social networking application, for example, but not limited to, e-mail application, calendar application, chat room application, instant messaging application, and photo management and sharing application. The website 710 may include server 118, one or more modules and one or more databases. The server 118 may be configured, programmed, and/or provided code instructions from one or more modules to receive data from a user terminal 110, verify the user's membership for accessing the website 710, transfer an award to the customer account upon use of the website 710 or accessing one or more web pages on the web site 710, and process the user's directive for redeeming the award towards a product or service.

The server 118 may be configured, programmed, and/or provided code instructions from one or more modules to determine at least one other person as a friend of the user accessing the website 710. In one embodiment, the server 118 may be configured, programmed, and/or provided code instructions from one or more modules to receive at least one photo posted on the website 710 by the user using the photo management and sharing application, and receive a request from the user to share with the at least one other person identified as a friend the at least one photo posted on the web-based system 700 by the user. The server 118 may then transfer an award to the customer account when the at least one other person identified as a friend views the at least one photo posted on the website 710. The server 118 may also transfer an award to the customer account for inviting at least one other person identified as a friend to join the website 710.

The website 710 may be implemented as one or more functional modules including interface module 121, processing module 122, social networking module 124, award manager module 138, advertising module 130 and registration module 136. According to an embodiment, the processing module 122 may be responsive to the receipt of data associated with the customer account upon log in to the online social network, and may be used to verify the user's membership for accessing the website 710. The award manager module 138 may be responsive to a request to access a webpage on the website 710. The award manager module 138 may be used to transfer an award to the customer account in response to the request received to access a webpage on the website 710. The award manager module 138 may be used to transfer to and/or accumulate the awards in the award database 146 for one or more user accounts. The award manager module 138 may also be used to process an individual's directive for redeeming the award towards a product or service.

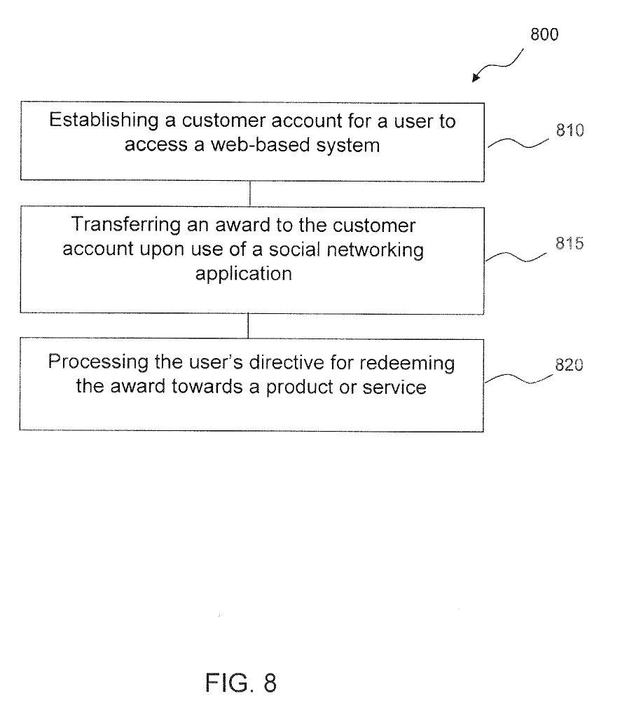

FIG. 8 illustrates an exemplary flowchart 800 outlining the operation of a web-based system for enhanced customer loyalty implemented for a social networking application, according to an embodiment of the present disclosure. The method of operation may include establishing a customer account for a user to access a web-based system (810), and transferring one or more awards to the customer account upon use of a social networking application (815). The web-based system may then process the user's directive for redeeming the award towards one or more products and/or services (820).

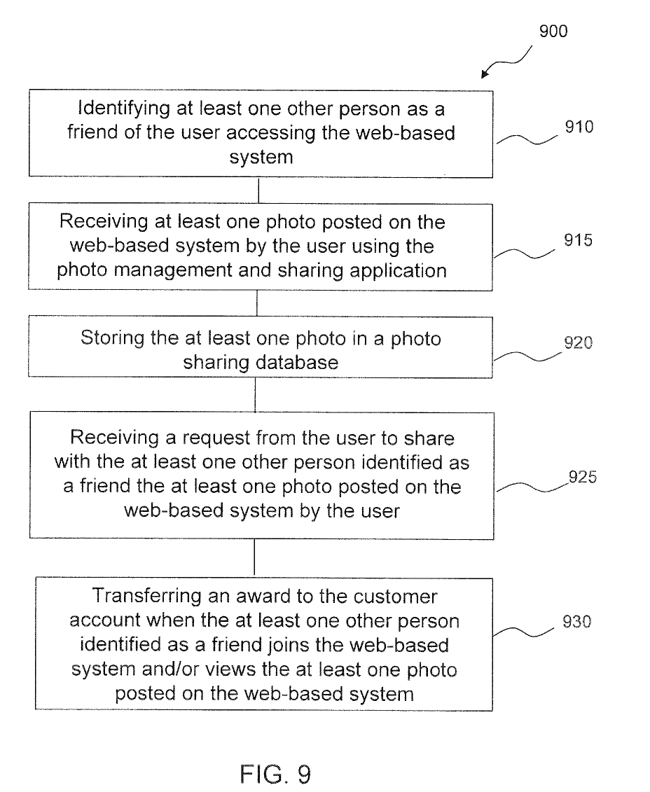

FIG. 9 illustrates an exemplary flowchart 900 outlining the operation of a web-based system for enhanced customer loyalty implemented for a photo management and sharing application, according to an embodiment of the present disclosure. The method of operation may include identifying at least one other person as a friend of the user accessing the web-based system (910), receiving at least one photo posted on the web-based system by the user using the photo management and sharing application (915), and storing the at least one photo in a photo sharing database 150 (920). Next, the web-based system may receive a request from the user to share with the at least one other person identified as a friend the at least one photo posted on the web-based system by the user (925). The web-based system may then transfer an award to the user's customer account when the at least one other person identified as a friend joins the web-based system and/or views the at least one photo posted on the web-based system (930).

As can be appreciated, the award may be redeemed towards a phone, satellite and/or internet service. For example, user terminal 110, such as a cell phone, may be used to access the social networking applications available on website 710. The cell phone may be equipped with a camera that can take photos and/or videos for uploading to the website 710 via the network 114. Once the photos and/or videos are viewed by an individual other than the user who uploaded the photo and/or video, the web-based system may then transfer and accumulate one or more awards to the user's account. The award may then be applied as a credit towards the user's cell phone account to reduce the cost of the user's cell phone bill. As such, the user will be incentivized to share more photos and/or videos with friends to reduce the cost of the cell phone bill. The telephone service provider benefits by providing an exclusive marketing program to consumers that allows them to reduce their cell phone bill while having fun taking photos and/or videos and sharing it with friends. The website service provider benefits from increased advertising revenue through the increased use and customer loyalty provided by the customer rewards system of the present disclosure.

While the customer rewards systems and methods have been described in terms of what are presently considered to be the most practical and preferred embodiments, it is to be understood that the disclosure need not be limited to the disclosed embodiments. It should also be understood that a variety of changes may be made without departing from the essence of the invention. Such changes are also implicitly included in the description. They still fall within the scope of this invention, It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

It should be understood that various modifications and similar arrangements are included within the spirit and scope of the claims, the scope of which should be accorded the broadest interpretation so as to encompass all such modifications and similar structures. The present disclosure includes any and all embodiments of the following claims.

1. A computer-implemented process for promoting customer loyalty to a website with a social networking application selected from a group consisting of an e-mail application, a calendar application, a chat room application, an instant messaging application, and a photo management and sharing application, the process comprising:
establishing online a customer account for a user to access the website;
receiving a first request code to access the social networking application of the website;
transferring an award associated with the customer account to an award database upon access of at least one webpage with the social networking application; and
processing the user's directive for redeeming the award towards a product or service.

2. The computer-implemented process of claim 1, wherein the award is selected from a group consisting of a dollar amount, a cash value and a credit point.

3. The computer-implemented process of claim 1, further comprising:
receiving a request to identify at least one other person as a friend of the user;
receiving at least one photo to post on the website by the user using the photo management and sharing application;
storing the at least one photo in a photo sharing database; and
receiving a second request code from the user to share with the at least one other person identified as a friend the at least one photo posted on the website.

4. The computer-implemented process of claim 3, further comprising transferring an award associated with the customer account to the award database when the at least one other person identified as a friend views the at least one photo posted on the website.

5. The computer-implemented process of claim 1, further comprising transferring an award associated with the customer account to the award database for inviting at least one other person identified as a friend to register with the website.

6. The computer-implemented method of claim 1, further comprising providing at least one advertisement for display on the at least one webpage with the social networking application.

7. The computer-implemented method of claim 1, wherein the award is applied as a credit towards the user's cell phone account.

8. A system for promoting customer loyalty to a website with a social networking application, the system comprising:
a first memory for storing a plurality of web pages, each of the plurality of web pages having a social networking application selected from a group consisting of an e-mail application, a calendar application, a chat room application, an instant messaging application, and a media management and sharing application;
a second memory for storing data associated with a customer account for a user to access the social networking application; and
a processor configured to:
receive the data from a user terminal,
verify the user's membership for accessing the social networking application, and
transfer an award to the customer account upon access to one of the plurality of web pages with the social networking application.

9. The system of claim 8, wherein the processor is further configured to process the user's directive for redeeming the award towards a product or service.

10. The system of claim 8, further comprising a photo sharing database for storing at least one image file.

11. The system of claim 8, further comprising:
means for receiving a request to identify at least one other person as a friend of the user;
means for storing at least one media file uploaded to the website by the user using the media management and sharing application;
means for receiving a request from the user to share with the at least one other person identified as a friend the at least one media file uploaded to the website.

12. The system of claim 11, wherein the processor is further configured to transfer an award to the customer account when the at least one other person identified as a friend views the at least one photo posted on the website.

13. The system of claim 8, wherein the processor is further configured to transfer an award to the customer account for inviting at least one other person identified as a friend to join the website.

14. A system for promoting customer loyalty to a website with a social networking application, the system comprising:
a database for storing data associated with a customer account for a user to access the social networking application;
a processing module responsive to the receipt of the data associated with the customer account upon log in to the website, the processing module verifying the user's membership for accessing the social networking application;
a social networking module responsive to a request to use a social networking application selected from a group consisting of an e-mail application, a calendar application, a chat room application, an instant messaging application, and a media management and sharing application; and
an award manager module responsive to a request to access a webpage on the social networking application, the award module transferring an award to the customer account in response to the request received, the award module storing the award in the database.

15. The system of claim 14, wherein the award manager module is responsive to a user's directive to redeem the award towards a product or service.

16. The system of claim 14, wherein the processing module is responsive to a user's request to identify at least one other person as a friend to access the social networking application, the processing module is responsive to a user's request to submit at least one media file for posting on the website using the media management and sharing application and share with the at least one other person identified as a friend, the processing module responsive to the at least one media file received and prompting the at least one other person identified as a friend to view the at least one media file.

17. The system of claim 16, wherein the award manager module is responsive to the user's request to share with the at least one other person identified as a friend the at least one media file, the award manager module transferring an award to the customer account in response to the at least one other person identified as a friend viewing the at least one media file posted on the website.

18. The system of claim 14, wherein the award manager module is responsive to a user's request to invite the at least one other person identified as a friend to sign up with the website, the award manager module transferring an award to the customer account in response to the invitation request.

19. The system of claim 14, further comprising an advertising module responsive to a request to access a webpage on the website, the advertising module retrieving from the database an advertisement to prompt for display on the webpage.

20. The system of claim 14, wherein the award is applied as a credit towards the user's cell phone account.
